(19) United States
(12) Patent Application Publication
(10) Pub. No.: US 2024/0031395 A1
(43) Pub. Date: Jan. 25, 2024

(54) CYBER ATTACK RESILIENCY ASSESSMENT SYSTEMS & METHODS

(71) Applicant: Sentar, Inc., Huntsville, AL (US)

(72) Inventors: Peter A. Kiss, Huntsville, AL (US); Kevin Scott Kuczynski, San Antonio, TX (US); Samer Vishnu Patel, Toney, AL (US); Deborah A. Williams, Manitou Springs, CO (US); Timothy R. Westran, Mount Pleasant, SC (US); Gary N. Mayes, Madison, AL (US)

(21) Appl. No.: 18/200,386

(22) Filed: May 22, 2023

Related U.S. Application Data
(60) Provisional application No. 63/391,633, filed on Jul. 22, 2022.

(51) Int. Cl. H04L 9/40; H04L 41/22

(52) U.S. Cl. CPC H04L 63/1433; H04L 63/1416; H04L 41/22

(57) ABSTRACT

The present disclosure generally pertains to cyber-attack resiliency assessment systems and methods. In some embodiments, the system may be configured to assess susceptibility of an operational system and its components to specific cyber-attacks and predict an impact of such attacks and impact to a mission which the operational system is intended to perform and complete.

### CROSS-REFERENCE TO RELATED APPLICATIONS

This application claims priority to U.S. Provisional Patent Application Ser. No. 63/391,633, filed Jul. 22, 2022 and entitled “Cyber Attack Resiliency Assessment Systems & Methods,” which is incorporated herein by reference in its entirety.

### STATEMENT REGARDING FEDERALLY SPONSORED RESEARCH OR DEVELOPMENT

This invention was made with Government support under Contract No. HQ0860-20-C-7122 awarded by the Missile Defense Agency, an agency of the U.S. Department of the Defense. The Government has certain rights in the invention.

### BACKGROUND

Reports of data breaches have become frequent among institutions and organizations of all sizes. The cyber-attacks at the root of such breaches are becoming more sophisticated, and harder to detect. Many believe that it is not a question of “if,” but “when” an organization will experience a cyber-attack.

It comes as little surprise, then, that cybersecurity is an increasingly important area of concern. Organizations may attempt to identify vulnerabilities present in their systems in order to ward off potential cyber-attacks. Physical and cybersecurity measures may be implemented to make it more difficult for a cyber-attack to succeed.

Despite these efforts, the rate of successful cyber-attacks continues to increase. Recognizing when a cyber-attack has occurred and identifying it quickly can reduce its impact. However, it is currently difficult to estimate potential impacts of a cybersecurity attack until after the attack has occurred. Improved methods for assessing cyber-attack resiliency are generally desirable.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 depicts a cyber-attack resiliency assessment system configured for assessing an operational system in accordance with some embodiments of the present disclosure.

FIG. 2 depicts a computing system of a cyber-attack resiliency assessment system in accordance with some embodiments of the present disclosure.

FIG. 3 depicts a graphical user interface (GUI) displaying a cyber-attack impact output to a user in accordance with some embodiments of the present disclosure.

FIG. 4 depicts a cyber-attack resiliency assessment method in accordance with some embodiments of the present disclosure.

### DETAILED DESCRIPTION

The present disclosure generally pertains to cyber-attack resiliency assessment systems and methods. In some embodiments, the system may be configured to assess susceptibility of an operational system and its components to specific cyber-attacks and predict an impact of such attacks and impact to a mission which the operational system is intended to perform and complete.

A cyber-attack is commonly seen as an attack, targeting an enterprise's use of cyberspace for the purpose of disrupting, disabling, destroying, or maliciously controlling a computing environment/infrastructure; or destroying the integrity of the data or stealing controlled information. As used herein the term “cyber-attack” may also include a set of actions performed by a threat actor to achieve such an attack and related information.

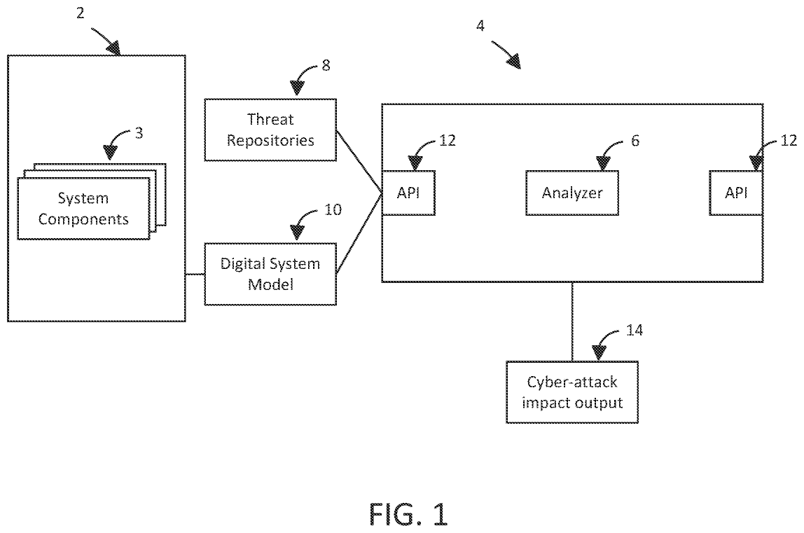

FIG. 1 depicts a cyber-attack resiliency assessment system 4 configured for assessing an operational system 2 in accordance with some embodiments of the present disclosure. The operational system 2 may have various components 3 susceptible to cyber-attack. The components 3 can include various physical and electronic systems, networks, devices, structures, and facilities, or virtually any other aspect of an operational system subject to a cyber-attack.

Example operational systems 2 can include, by way of non-limiting example only: one or more utility sites, such as a power transmission station, a water treatment and collection facility, a telecommunications hub, or similar facility; a heating, ventilation and cooling (HVAC) system; a plumbing system; a weapon system, a military installation, such as a missile facility or similar system; and a computing or data storage facility. Other types of operational systems 2 may be possible in some embodiments.

Example components 3 may include one or more physical components commonly associated with one or more operational systems 2. Example components 3 may include, in some embodiments, a sensor (e.g., any of the various sensors produced by TE Connectivity Corporation, such as automotive sensors, fluid sensors, force sensors, flow sensors, optical sensors, speed/vibration/torque sensors, or other types of sensors manufactured by other manufacturers), an actuator, one or more components of a programmable logic controller (“PLC”), one or more components of a remote terminal unit (“RTU”), one or more components of a distributed control system (“DCS”), one or more components of building management system (“BMS”), one or more components of building automation system (“BAS”), building energy management system (“EMS”), one or more components of a HVAC system, etc.

Aspects of various cyber-attack threats can be included in threat repositories 8, which can include information about various cyber threat and attack vectors. The repositories 8 can include various data sources describing the universe of cyber threats, and in some embodiments, can include such data from various sources of information, such as MITRE ATT&CK® (any and all versions, and version 13 in particular), MITRE CAPEC (any and all versions, and version 3.7 in particular), NIST National Vulnerability Database (NVD) (any and all versions), domain specific data threats, and other sources and types of data threats. The repositories 8 can include various storage media capable of storing attack and threat data, including databases, static and dynamic memory, terminals, or otherwise.

In some embodiments, a threat repository 8 may comprise information provided by one or more commercially available cybersecurity software platforms or services. Examples may include information generated by one or more Dragos® products from the Dragos, Inc. cybersecurity software company, such as the current version of the Dragos® SITESTORE software, the Dragos® Playbooks software, or otherwise; from Siemens® cybersecurity software company, such as the current version of the Siemens® SIBERprotect™ software. Other types of commercially available software platforms or services are possible in some embodiments.

In some embodiments, a threat repository 8 may comprise information providing visibility of industrial control systems (“ICS”) and operational technology (“OT”) resources, such as may be provided by the Dragos® products mentioned above or other products. Such information may describe ICS/OT assets and the associated cyber threats, coupled with best-practice guidance to respond before a significant compromise occurs.

In some embodiments, a threat repository 8 may comprise rulesets provided by Siemens® SIBER protect software that are configured based on the systems 2 monitored and assessed by the system 4 and specific components 3 of such systems 2. Such rulesets may provide rules for responding to one or more various cyber threats, and responding in Real-time to OT cyber threats. Such rulesets may be used to provide control signals to the one or more components 3 of the systems 2 to take physical response actions in response to cyber threats, especially high-priority threats. In this regard, such rulesets may allow the system 4 to prevent, limit, or quickly remedy cyber threats and attacks while altering a state of one or more components 3 or one or more systems 2 to prevent damage or compromise of physical resources such as equipment associated with a cyber threat or attack.

The digital system model 10 can include models of various components 3 of the operational system 2. In some embodiments, the model 10 can include various representations of a defense system, including a digital representation of a defense system, which can be generated by owners or stakeholders of the operational system 2 and can describe some or all aspects of the system for various activities it may perform during its life cycle. The model 10 can include sufficient technical data regarding one or more components of the system 10 to allow the assessment of system vulnerabilities described further below. The model 10 can be stored on various storage media capable of storing such information, including databases, static and dynamic memory, terminals, or otherwise.

Information from the model 10 can be provided to system 4 to facilitate implementation by system 4 of a digital twin of one or more physical components 3 of the system 2. In some embodiments, the assessment system 4 may be configured to allow a user and the assessment system 4 (e.g., control logic 40 and analyzer 6) to interact with one or more physical components 3 via a digital twin implemented by the model 10 and provided to the assessment system 4.

A digital twin from model 10 may allow a user or the system 4 to receive information regarding a state of a physical component 3 and to provide control signals to control the state of the component 3. For example, the assessment system 4 may be configured to implement one or more digital twins of an actuator 3 of a power generation substation (such as an actuator 3 coupled to a lockout switch of the power generation substation). Model 10 may have one or more virtual models of the actuator 3. The one or more virtual models may be provided by the model 10 to assessment system 4, which may store the one or more virtual models as model data 46. The model data 46 may be displayed graphically to a user via user interface 34 (e.g., via a GUI implemented by a display, such as a monitor, touchscreen or similar).

From time to time, such as when an assessment by the analyzer 6 suggests that the actuator 3 will be impacted by an anticipated cyber threat, the assessment system 4 or user may control a state of the actuator 3 by interacting with the digital representation or model of the actuator 3. Such interaction may cause the assessment system 4 to provide control signal to the actuator 3 to change the state of the lockout switch 3 (e.g., from an unlocked to a locked state). The assessment system 4 may be configured to control a state of one or more other components 3 of the system 2, either in response to user commands via user interface 34 or responsive to control logic 40 based on determinations by analyzer 6. Such control signals may change a state of the component 3 and may cause the component 3 or system 2 to take one or more of various actions, including to commence, end, modify or otherwise conduct operations of the component 3.

The cyber-attack resiliency assessment system 4 includes a cyber mission analyzer 6 that is in communication with threat repositories 8 and system models 10 via an application programming interface (“API”) 12. The analyzer 6 can receive data from the threat repositories 8 and system model 10 and analyze it to predict a mission impact from various cyber-attack threats, as described further below. The system 4 can determine, via analyzer 6, a cyber-attack prediction that is indicative of observable impacts on operational components of the system 2 and provide it to a user as a cyber-attack impact output 14.

Cyber-attack impact output 14 can include information regarding a mission impact presented by specific cyber-attacks, and may indicate observable impacts that a user can reference to make decisions. The output 14 may include various media perceptible by a user, such as a textual or audiovisual output (a report, video, etc.). As described further below, this may allow a user to prioritize resources to achieve improved resiliency and redundancy for preserving mission performance.

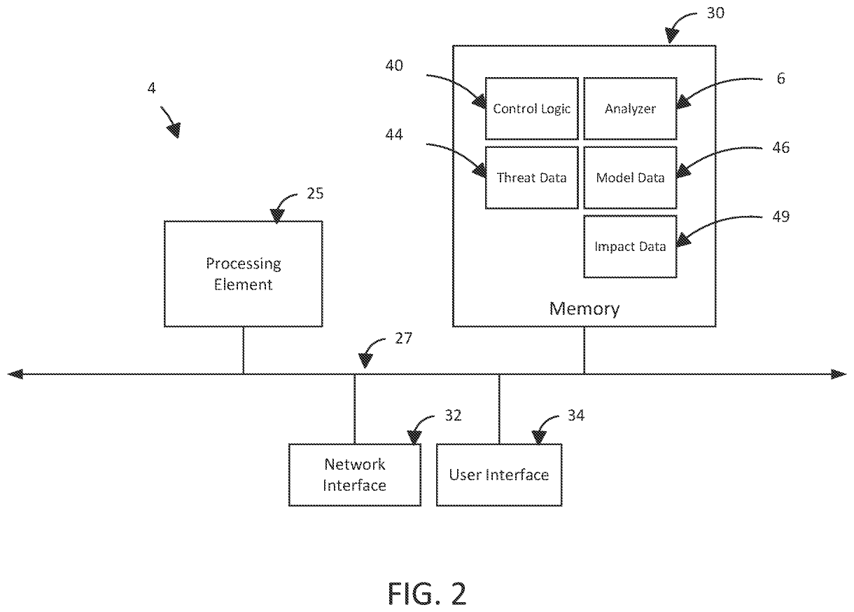

FIG. 2 depicts a cyber-attack resiliency assessment system 4 in accordance with some embodiments of the present disclosure. The system 4 is depicted as a computing system 4, and in the exemplary system 4 depicted by FIG. 2, comprises at least one conventional processing element 25, such as a digital signal processor (DSP) or a central processing unit (CPU), that communicates to and drives the other elements within the system 4 via a local interface 27, which can include at least one bus. In some embodiments the local interface 27 can include one or more communication buses such as inter-integrated circuit (FC), serial peripheral interface (SPI), universal serial bus (USB), universal asynchronous receiver-transmitter (UART), and general-purpose input/output (GPIO). Local interface 27 is also communicatively coupled with memory 30, which is described further below. In one embodiment, the processing element 25 may execute instructions of the memory 30 and based on those instructions may communicate with the other components of system 4 via the communication buses of interface bus 27.

The processing element 25 is configured to retrieve and execute instructions of software stored in memory 30. And to execute instructions stored in memory 30 to control one or more other components of or in communication with system 4.

The system 4 has a network interface 32 that is configured to exchange information with one or more devices via at least one network (e.g., LAN, WAN, the Internet, etc.). The network interface 32 further may comprise software (e.g., API 12), hardware or any combination of hardware and software for coupling system 4 communicatively with one or more data sources, including repositories 8, models 10, or otherwise.

Furthermore, a user interface 34, for example, a printer, monitor, touch screen, liquid crystal display (LCD), etc., can be used to output data, including output 14, to a user of the system 4. In one exemplary embodiment, the system 4 comprises a touchscreen, which can be used to implement the user interface 34. In this regard, the touchscreen is configured to display information to the user, and accept inputs from the user, via capacitive sensing or otherwise, when the user touches the touchscreen. In other embodiments, the system 4 may comprise a separate input interface, such as a keyboard, keypad, or mouse for receiving inputs from a user. The system 4 may have other components in some embodiments.

The memory 30 can be various types of data storage components including: a server, a database, a flash drive, random access memory (RAM), random only memory (ROM) and other data storage media. The memory 30 stores threat data 44, model data 46, impact data 49, control logic 40 and analyzer 6, but other information may be stored in memory 30 in some embodiments.

Analyzer 6 may be implemented in software or firmware and can analyze information from repositories 8 and digital model 10, as will be described in more detail hereafter. The control logic 40 and analyzer 6 can be implemented in software, hardware, firmware, or any combination thereof. In the exemplary embodiment illustrated by FIG. 2, the control logic 40 and analyzer 6 is implemented in software and stored in memory 30 of the system 4.

Threat data 44 can include data from threat repositories 8, as well as other information indicative of or describing cyber threats. In some embodiments, threat data 44 can include one or more of incident response playbooks (e.g., Dragos® incident response playbooks) and preconfigured rulesets (SIBERProtect rulesets).

Model data 46 can include data from models 10, as well as other information digitally representing aspects of the operation system 2 and its various components 3.

Impact data 49 can include mission impact score data, data used to determine a mission impact score as described further below, as well as any other data related to a determination by the system 4 of a mission impact prediction score. This can include various data, by way of example, data related to: a mission impact score scale, mission impact criteria, an overall mission impact score, mapping of observable impacts to operational components, mapping of attack vectors to mission dependencies, or various other information that may be used by control logic 40 or by analyzer 6 as part of its determination of potential impact to mission assessed by analysis of a cyber-attack threat. Further, the impact data 49 may comprise one or more lists generated for provision to a user based on analysis by analyzer 6, including, for example, impacted components lists, threat lists, The data further may comprise information regarding groupings such as an impact determination group. Other data related to impact assessments performed by the system 4 and analyzer 6 may be stored in memory 30 as impact data 49 in order to achieve the functionality described herein.

Control logic 40 may include various instructions for generally controlling the operations of the system 4, including receipt of information from repositories 8 and digital model 10, providing such data to analyzer 6, and providing output generated by analyzer 6 to one or both of network interface 32 and user interface 34.

In some embodiments, analyzer 6 and control logic 40, either separately or together, can comprise instructions and logic configured to cause, when executed by the processing element 25, the system 4 to perform operations described herein ascribed to system 4.

Note that impact data 49, while specifically shown as a separate data item 49 in the embodiment of FIG. 2, in some embodiments may be stored in memory 30 either as part of data within analyzer 6, or as either or a combination of threat data 44, model data 46, or other information stored in memory 30.

The system 4 may encapsulate the analysis of threat/attack vectors, map to mission dependencies, and predict mission operational impacts, thus enhancing the cyber resilience of the operational/mission system. System 4 can facilitate and improve cyber resilience, i.e., the ability to respond to and recover from a cyber-attack, by assessing mission operations (e.g., information regarding systems and networks critical to mission execution stored in model data 46) against a catalog of known cyber-attacks (e.g., data 44). The system 4 can provide details of anticipated impacts to mission execution to a user, such as via output 14. The system 4 can provide output 14 for incorporation into organizational risk assessment constructs to meet a variety of end-states and supports cyber resiliency focused efforts to include, but not limited to, cyber modeling and simulation, decision support for cyber missions, and risk management approaches.

In some embodiments, the system 4 may be configured to analyze cyber-attacks in the context of mission behavior and provide a proactive operational system mission impact predictive analysis which focuses on “what” happens to the mission execution based on successful cyber-attacks (e.g., susceptibility vs. vulnerability). The system 4 may produce a relevant mission impact prediction score which may be indicative of a level of operational impact to the system 2 for each cyber-attack. Such emphasis on susceptibility versus vulnerability may provide users with a non-traditional analytical capability for cybersecurity. Whereas traditional assessments focus on system component vulnerabilities, the system 4 instead may promote significance of impact to system performance and associated mission sets. In doing so, the system 4 can provide a risk management capability and allow decision makers to prioritize a “cyber-first mindset” during risk mitigation planning, development, and engineering.

As noted above, a mission impact prediction score may indicate one or more impacts to system 2 including one or more of: a system, components, mission, and user preferences. In some embodiments, a mission impact score may be based on one or more behavioral characteristics of the system 2, as well as a prediction of mission degradation caused by a particular type of attack (e.g., a mission impact score of 5 may be associated with a denial of service attack resulting in a prediction of complete mission degradation). Example scoring and rubric information are discussed further below. In some embodiments, a mission impact score may be configured based on and to include one or more of the foregoing. Other impacts may be accounted for in the scoring system in some embodiments. Each may be stored in memory 30 as impact data 49.

In an embodiment, an example mission impact prediction score scale may comprise a scale ranging from 1 to 5, with levels of severity increasing as the scale increases numerically. Each level of the scale may be analogous to a weighted value indicative of severity. An attack that is the most severe type of attack (e.g., level 5) can result in an impact that denies or degrades performance of a component 3 in a manner that can render the mission ineffective. An attack that is the next most severe type of attack (e.g., level 4) can cause significant disruption or degradation to a component's behavior in a manner that results in mission degradation and could render the mission ineffective. An attack that is the next most severe type of attack (e.g., level 3) has some ability to disrupt a component's behavior during mission execution. Such impact is limited and/or recoverable. Capabilities or redundancies are in place that allow the component to execute its mission function with minor degradation. An attack that is the next most severe type of attack (e.g., level 2) creates an impact that is relatively minor, and not likely to affect component's performance in a manner that degrades or disrupts the mission. An attack that is the least severe type of attack (e.g., level 1) is detectable and ineffective due to aspects of the system design that reliably negate or effectively mitigate the impact.

The system 4 also may be configured to use the values (weights) from the mission impact prediction score scale to determine a score for one or more impact criteria. In some embodiments, example impact criteria may include: component criticality (either tied to a particular domain or not); an observable impact (either tied to a particular domain or not); and a sequence phase (unique to a particular domain in some embodiments). Component criticality criteria may refer to how critical to a particular mission a component is, which may depend on a user's particular mission and the particular mission for which the desired impact prediction score is performed. An observable impact criteria may refer to a degree of significance or impactfulness that the observable has for the user's particular mission and the particular mission for which the desired impact prediction score is performed. Sequence phase criteria may refer to how critical to a particular mission a sequence or phase of a sequence is, which also may depend on a user's particular mission and the particular mission for which the desired impact prediction score is performed. Other criteria may be used in other embodiments.

For each of the mission impact criteria, the system 4 may determine a score (e.g., from 1-5 indicating a level of mission impact as described above). The system 4 may reference the various threat repositories and other information described herein in order to determine the score. Based on the available information, the system 4 may determine for each criterion one or more mission impact scores (e.g., 1-5) and assign the determined mission impact score to such criterion. The system 4 may average the determined mission impact scores to arrive at an overall mission impact score for a particular scenario. Other score derivation techniques are possible in some embodiments, and may be applied in some or all scenarios to the one or more scoring criterion.

The system 4 may be configured to support various technology requirements by delivering an effects-based cyber defense analytics designed to preserve operational missions. The system 4 may catalogue cyber-attacks and aligning them to mission specific assets (components 3). This cataloguing process may use a variety of threat data sets in data 44 from repositories 8, including, by way of example only: Common Attack Pattern Enumeration and Classification (CAPEC) (Version 3.7, 2022), Common Vulnerabilities and Exposures (CVE) (July 2022), Common Weakness Enumeration (CWE) (Version 4.8, 2022) and the Adversarial Tactics, Techniques & Common Knowledge (ATT&CK) (Version 11, 2022) framework. Other threat data and repositories are possible.

As shown in FIG. 1, an Application Programming Interface (API) may be implemented to decouple the analysis process from both the data source as well as the data sink. The API may enable the analyzer 6 interface with a variety of stakeholder-defined data sources as well as a variety of stakeholder-defined data sinks, from display dashboards to simulation environments and Artificial Intelligence (AI)-driven downstream analytics engines. This approach ensures that clients have baseline models that evolve in tandem with the changing cyber-attack threat-space. By tailoring the system 4 and its analysis capabilities to specific missions, data flows, and mission assets, explicit impact models can be generated and provided directly provide decision support for cyber missions and promote prioritization of investments in resiliency and/or redundancy within specific mission parameters.

In some embodiments, the system 4 may be configured to provide one or more cyber mission impacts to simulation frameworks, increasing their fidelity through the incorporation of cyber effects. By mapping the impacts in the context of events that happen to mission operations and times during the mission sequences when those impacts appear, the system may provide a sound predictive capability for ingest of cyber effects into mission simulations. By implementing the system 4 as a proactive defensive technology, organizations can advance cybersecurity practices through a standard, objective, and repeatable mission-specific impact analysis and provide decision makers with greater insight into the effects of cyber-attacks on their unique operational systems and corresponding mission sets.

In some embodiments, the system 4 may be configured to implement one or more exemplary techniques for providing cyber-attack resiliency assessments. As an example of such techniques, in some embodiments, system 4 may be configured to assess an impact of a cyber-attack on the operational system 2. In some embodiments, the analyzer 6 may determine at least one observable impact of a cyber-attack on an operation of the operational system 2, such as by consulting information stored in threat data 44. The analyzer 6 may map the at least one observable impact to one or more components 3 of the operational system 2 so that the observable impacts are associated with the one or more components 3. The analyzer 6 further may determine an impact prediction score for the at least one observable impact. In some embodiments, the impact prediction score may be indicative of an impact (e.g., mission impact) of the cyber-attack to operation of the one or more components 3 of the operational system 2.

The analyzer 6 further may generate a list of cyber-attack impact events associated with the cyber-attack. In some embodiments, the impact events may be ranked within the list based on a prioritization of the events. In some embodiments, the prioritization of the events may be based on the impact prediction score associated with the at least one observable impact.

In some embodiments, the one or more of the analyzer 6 or control logic 40 may provide the list to a user, such as via user interface 34 (as part of output 14).

In some embodiments, the analyzer 6 may determine an impact to a mission of the operational system 2 as part of determining at least one observable impact. The impact may be quantified in various ways, including one or more of: a score; a degree (e.g., low, medium, high, etc.); a description (e.g., low impact, mission critical, etc.); or otherwise. The impact may be stored in impact data 49.

In some embodiments, the one or more components 3 may comprise at least one of: a physical device; a network interface; a network; a data packet; a data object; a data protocol; and a software application. Other types of components 3 are possible in some embodiments.

In some embodiments, the analyzer 6 may generate an impacted-components list for the operational system 2. Impacted components 3 of system 2 may be ranked within the impacted components list based on a prioritization of the components 3. In some embodiments, a prioritization of the components may be based on the impact prediction score associated with the at least one observable impact, as described above.

In some embodiments, the analyzer 6 may be further configured to receive cyber threat data. The cyber threat data may indicate aspects of one or more cyber threats. The analyzer 6 may group the one or more cyber threats into at least one of an attack group and a consequence group based on the cyber threat data. In some embodiments, a cyber threat may be grouped into at least a consequence group if the cyber threat data indicates a consequence associated with the cyber threat. In some embodiments, the cyber threat may be grouped into at least an attack group if the cyber threat data indicates an attack type associated with the cyber threat.

In some embodiments, the analyzer 6 may associate the consequence group with at least one system impact category. In some embodiments, the at least one system impact category may be indicative of a direct impact of at least one cyber threat within the consequence group on at least one component of the system.

In some embodiments, the analyzer 6 further may generate a list of impact determination groups. The list impact determination group may be based on an association between the consequence group and the at least one attack group. The list may be stored in impact data 49.

In some embodiments, the analyzer 6 may associate the list of impact determination groups with at least one observable impact. The analyzer 6 further may determine an impact prediction score for each impact determination group in the list, and the impact prediction score may be based on the at least one observable impact.

The analyzer 6 further may determine an impact prediction based on each impact prediction score, and the impact prediction score may be determined using a process comprising one or more of: artificial intelligence; machine learning; mathematical modeling; statistical modeling; and a neural network. The impact prediction and impact prediction score may be stored in impact data 49.

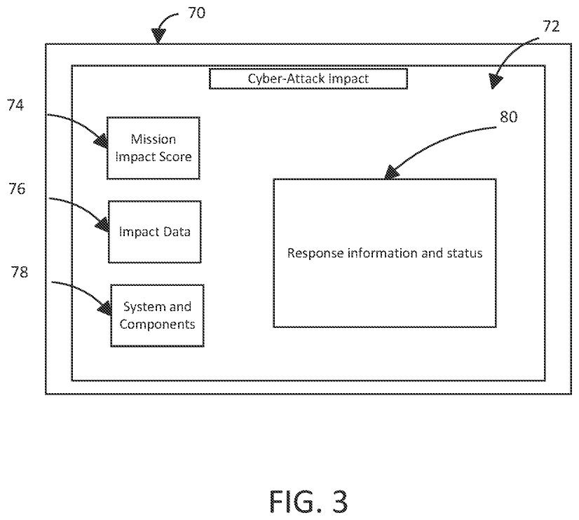

FIG. 3 depicts a graphical user interface (GUI) 70 displaying a cyber-attack impact output 72 to a user in accordance with some embodiments of the present disclosure. The GUI 70 may be implemented by user interface 34 in some embodiments. In some embodiments, the GUI 70 may be implemented based on a commercial software product, such as one or more of security information and event management tools (SIEM) or security orchestration, automation, and response tools (SOAR), which may implement artificial intelligence techniques. The GUI 70 may display mission impact score 74 to a user, as well as other information determined by the analyzer 6. Essentially any information related to a cyber risk assessment or otherwise available to system 4 may be displayed via GUI 70. Graphical object 74 may provide information in graphical format that is indicative of a mission impact score determine by analyzer 6. Graphical object 76 may provide a graphical indication to a user regarding impact prediction and scoring information, such as may provide pursuant to assessment by the analyzer 6. Visual representations of one or more systems 2 and components 3 may be provided, such as graphical object 78. Further, a response information and status indication may be provided as graphical object 80, such as an incident response playbook for implementation or ruleset pre-configured for implementation at a particular system 2 or component 3.

In some embodiments, the output 72 may enable real-time mitigation of the detected or assessed cyber-attack risk and impact. Control signals may be provided to one or more components 3 of a system 2 in order to control a state of the one or more components 3. The control signals may be provided via network interface 32, and may be responsive to prompt or input by a user, determination or assessment by the analyzer 6, or other initiating event.

In this regard, the above features of the system 4 may enable various technical improvements and practical implementation in components of physical systems. Physical systems are modeled and rendered digitally for monitoring and control by control signals from system 4. The models facilitate improved reliability and control for physical systems in a way humans cannot achieve by recognizing observable impacts, mapping the impacts to one or more components, and controlling a state of one or more components 3 and systems 2 in response. The system 4 further can use information about the system 2 and components 3 to determine an impact prediction score for the at least one observable impact. The score is practically implemented into a physical system and response because it is tied to an impact of the cyber-attack to operation of the one or more components of the operational system. In this regard, the system 4 goes beyond abstraction and is grounded in application for real, physical systems and components. Further, the user can implement a response playbook or ruleset via control signals to the physical components 3 of the system 2 based on the assessed and generated impacts, such as the impact prediction score associated with the at least one observable impact. The foregoing demonstrate a practical application of the system 4 beyond a generic computing environment and into a real-world application in the context of the various physical operational systems and environments subject to cyberattack. By enabling recognition of the impacts of an attack, determining elements and components of the system impacted by the attack, mapping the impacts to those components, predicting impacts of the attack on the component and scoring and prioritizing such impacts based on the components and the mission of the component and system, and then providing an output indicative of the above for action by a user or by the system 4 via control signals to the systems and their components, significant and meaningful improvements are achieved in assessment of a system's resiliency to cyber-attacks.

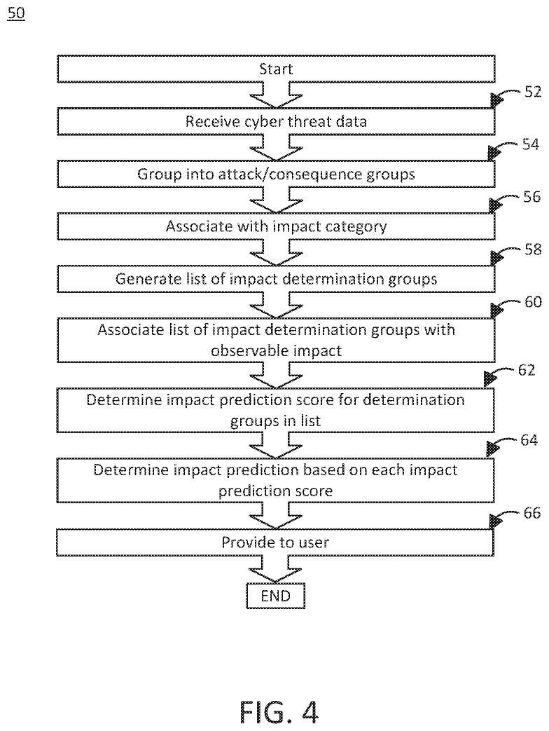

FIG. 4 depicts a cyber-attack resiliency assessment method in accordance with some embodiments of the present disclosure.

In some embodiments, process 50 may begin at step 52 by receiving cyber threat data, wherein cyber threat data indicates aspects of one or more cyber threats. The data can be received from repositories 8. In some embodiments, system also may receive other data, such as models 10, or otherwise. Thereafter, processing may continue to step 54.

At step 54, processing may continue by grouping the one or more cyber threats into at least one of an attack group and a consequence group based on the cyber threat data. A cyber threat may be grouped into at least a consequence group if the cyber threat data indicates a consequence associated with the cyber threat, and the cyber threat is grouped into at least an attack group if the cyber threat data indicates an attack type associated with the cyber threat. After the one or more cyber threats has been grouped in to at least one of an attack group and a consequence group, processing may proceed to step 56.

At step 56, the consequence group may be associated with at least one system impact category. In some embodiments, the at least one system impact category may be indicative of a direct impact of at least one cyber threat within the consequence group on at least one component of the system. Thereafter, processing may proceed to step 58.

At step 58, processing may continue by generating a list of impact determination groups, wherein each impact determination group is based on an association between the consequence group and the at least one attack group. Thereafter, processing may proceed to step 60.

At step 60, processing may continue by associating the list of impact determination groups with at least one observable impact. Thereafter, processing may proceed to step 62.

At step 62, processing may continue by determining an impact prediction score for each impact determination group in the list, wherein the impact prediction score is based on the at least one observable impact. Thereafter, processing may proceed to step 64.

At step 64, processing may continue by determining an impact prediction based on each impact prediction score. Thereafter, processing may proceed to step 66, where each impact prediction may be provided to a user, such as via output 14.

Thereafter, processing may end.

The foregoing description illustrates and describes the processes, machines, manufactures, compositions of matter, and other teachings of the present disclosure. Additionally, the disclosure shows and describes only certain embodiments of the processes, machines, manufactures, compositions of matter, and other teachings disclosed, but, as mentioned above, it is to be understood that the teachings of the present disclosure are capable of use in various other combinations, modifications, and environments and is capable of changes or modifications within the scope of the teachings as expressed herein, commensurate with the skill and/or knowledge of a person having ordinary skill in the relevant art.

The embodiments described hereinabove are further intended to explain certain best modes known of practicing the processes, machines, manufactures, compositions of matter, and other teachings of the present disclosure and to enable others skilled in the art to utilize the teachings of the present disclosure in such, or other, embodiments and with the various modifications required by the particular applications or uses. Accordingly, the processes, machines, manufactures, compositions of matter, and other teachings of the present disclosure are not intended to limit the exact embodiments and examples disclosed herein. Any section headings herein are provided only for consistency with the suggestions of 37 C.F.R. § 1.77 or otherwise to provide organizational queues. These headings shall not limit or characterize the invention(s) set forth herein.

What is claimed is:

1. A method for assessing an impact of a cyber-attack on a physical, operational system by one or more processors of a cyber-attack assessment system, comprising:
determining at least one observable impact of a cyber-attack on an operation of the operational system;
mapping the at least one observable impact to one or more physical components of the operational system;
determining an impact prediction score for the at least one observable impact, wherein the score is indicative of an impact of the cyber-attack to operation of the one or more components of the operational system;
generating a list of cyber-attack impact events associated with the cyber-attack, wherein impact events are ranked within the list based on a prioritization of the events, and wherein the prioritization of the events is based on the impact prediction score associated with the at least one observable impact; and
providing the list to a user.

2. The method of claim 1, wherein the determining at least one observable impact comprises determining an impact to a mission of the operational system, and wherein the mission comprises at least one of: an operational status of the system, an efficiency rating of the system, a desired output of the system, and an availability time of the system.

3. The method of claim 1, wherein the one or more components comprises at least one of: a physical device; a network interface; a network; a data packet; a data object; a data protocol; and a software application.

4. The method of claim 1, further comprising an impacted components list for the operational system, wherein the impacted components are ranked within the impacted components list based on a prioritization of the components, and wherein the prioritization of the components is based on the impact prediction score associated with the at least one observable impact.

5. The method of claim 1, further comprising:
receiving cyber threat data, wherein cyber threat data indicates aspects of one or more cyber threats;
grouping the one or more cyber threats into at least one of an attack group and a consequence group based on the cyber threat data, wherein a cyber threat is grouped into at least a consequence group if the cyber threat data indicates a consequence associated with the cyber threat, and wherein the cyber threat is grouped into at least an attack group if the cyber threat data indicates an attack type associated with the cyber threat;
associating the consequence group with at least one system impact category, wherein the at least one system impact category is indicative of a direct impact of at least one cyber threat within the consequence group on at least one component of the system;
generating a list of impact determination groups, wherein each impact determination group is based on an association between the consequence group and the at least one attack group;
associating the list of impact determination groups with at least one observable impact;
determining an impact prediction score for each impact determination group in the list, wherein the impact prediction score is based on the at least one observable impact; and
determining an impact prediction based on each impact prediction score.

6. The method of claim 1, wherein the impact prediction score is determined using a process comprising one or more of: artificial intelligence; machine learning; mathematical modeling; statistical modeling; and a neural network.

7. A method for assessing an impact of a cyber-attack on an operational system by one or more processors of a cyber-attack assessment system, comprising:
receiving cyber threat data, wherein cyber threat data indicates aspects of one or more cyber threats;
grouping the one or more cyber threats into at least one of an attack group and a consequence group based on the cyber threat data, wherein a cyber threat is grouped into at least a consequence group if the cyber threat data indicates a consequence associated with the cyber threat, and wherein the cyber threat is grouped into at least an attack group if the cyber threat data indicates an attack type associated with the cyber threat;
associating the consequence group with at least one system impact category, wherein the at least one system impact category is indicative of a direct impact of at least one cyber threat within the consequence group on at least one component of the system;
generating a list of impact determination groups, wherein each impact determination group is based on an association between the consequence group and the at least one attack group;
associating the list of impact determination groups with at least one observable impact;
determining an impact prediction score for each impact determination group in the list, wherein the impact prediction score is based on the at least one observable impact; and
determining an impact prediction based on each impact prediction score.

8. A cyber-attack assessment system, comprising
a user interface;
one or more processors;
memory coupled to the one or more processors and configured to store cyber-attack impact assessment instructions, which when executed by the one or more processors, cause the one or more processors to perform operations comprising:
determining at least one observable impact of a cyber-attack on an operation of an operational system;
mapping the at least one observable impact to one or more components of the operational system;
determining an impact prediction score for the at least one observable impact, wherein the score is indicative of an impact of the cyber-attack to operation of the one or more components of the operational system;
generating a list of cyber-attack impact events associated with the cyber-attack, wherein impact events are ranked within the list based on a prioritization of the events, and wherein the prioritization of the events is based on the impact prediction score associated with the at least one observable impact; and
providing, via the interface, the list to a user.

9. The system of claim 8, wherein the determining at least one observable impact comprises determining an impact to a mission of the operational system.

10. The system of claim 8, wherein the one or more components comprises at least one of: a physical device; a network interface; a network; a data packet; a data object; a data protocol; and a software application.

11. The system of claim 8, further comprising an impacted-components list of impacted components of the operation system, wherein the impacted components are ranked within the impacted components list based on a prioritization of the components, and wherein the prioritization of the components is based on the impact prediction score associated with the at least one observable impact.

12. The system of claim 11, further comprising:
receiving cyber threat data, wherein cyber threat data indicates aspects of one or more cyber threats;
grouping the one or more cyber threats into at least one of an attack group and a consequence group based on the cyber threat data, wherein a cyber threat is grouped into at least a consequence group if the cyber threat data indicates a consequence associated with the cyber threat, and wherein the cyber threat is grouped into at least an attack group if the cyber threat data indicates an attack type associated with the cyber threat;
associating the consequence group with at least one system impact category, wherein the at least one system impact category is indicative of a direct impact of at least one cyber threat within the consequence group on at least one component of the system;
generating a list of impact determination groups, wherein each impact determination group is based on an association between the consequence group and the at least one attack group;
associating the list of impact determination groups with at least one observable impact;
determining an impact prediction score for each impact determination group in the list, wherein the impact prediction score is based on the at least one observable impact; and
determining an impact prediction based on each impact prediction score.

13. The system of claim 8, wherein the impact prediction score is determined using a process comprising one or more of: artificial intelligence; machine learning; and a neural network.
